(19) United States
(12) Patent Application Publication
(10) Pub. No.: US 2013/0069383 A1
(43) Pub. Date: Mar. 21, 2013

(54) GRAPPLE WITH FULLY ENCLOSED HYDRAULIC CYLINDERS

(71) Applicants: David Sunde, Corona, CA (US); Michael Frabotta, Yorba Linda, CA (US)

(72) Inventors: David Sunde, Corona, CA (US); Michael Frabotta, Yorba Linda, CA (US)

(21) Appl. No.: 13/427,129

(22) Filed: Mar. 22, 2012

Related U.S. Application Data
(60) Provisional application No. 61/466,213, filed on Mar. 22, 2011.

(51) Int. Cl. B66C 1/42

(52) U.S. Cl. CPC B66C 1/427
USPC 294/198

(57) ABSTRACT

A grapple is provided having (a) a first jaw hinged together with a second jaw and (b) a pair of hydraulic cylinders disposed on opposite sides of the jaw. Both of the cylinders are capable of opening and closing the hinged jaws without the use of a stiff arm. In one embodiment of the invention, the pair of hydraulic cylinders are fully enclosed within a compartment within one of the jaws.

### CROSS-REFERENCE TO RELATED APPLICATIONS

This application claims priority from Provisional Patent Application Ser. No. 61/466,213, filed Mar. 22, 2011, entitled GRAPPLE WITH FULLY ENCLOSED HYDRAULIC CYLINDERS, which is incorporated in its entirety herein.

### FIELD OF THE INVENTION

This invention relates generally to lifting equipment, specifically to lifting equipment known in the trade as grapples.

### DRAWINGS

These and other features, aspects and advantages of the present invention will become better understood with reference to the following description, appended claims and accompanying drawings where:

FIG. 1 is a perspective non-exploded view of a grapple having features of the invention; and

FIG. 2 is an exploded perspective view of the grapple illustrated in FIG. 1.

### DETAILED DESCRIPTION OF THE INVENTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a grapple as illustrated in the attached drawings.

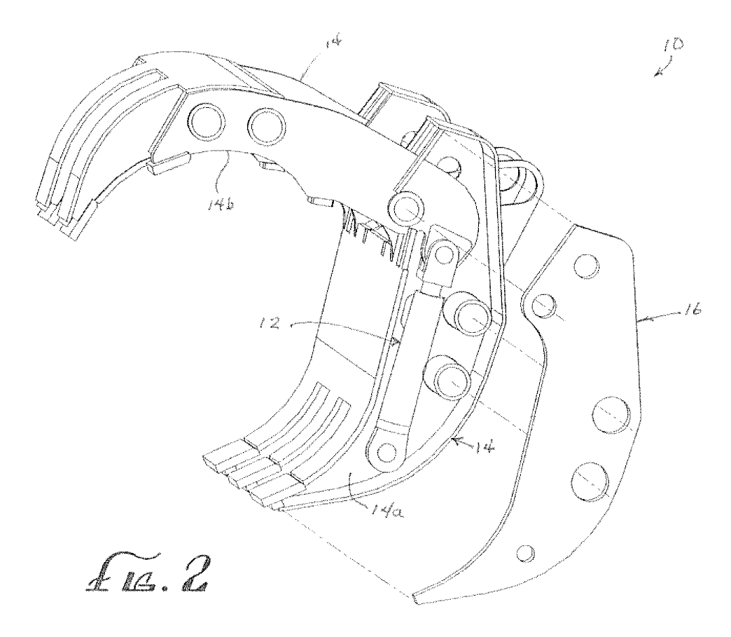

As is conventional with most prior art grapples, the grapple of the invention 10 uses a pair of hydraulic cylinders 12 to power a pair of hinged jaws, a first jaw 14a and a second jaw 14b, between open and closed positions. FIG. 2 is an exploded view of the grapple of the invention 10, illustrating the location and configuration of one of the hydraulic cylinders 12.

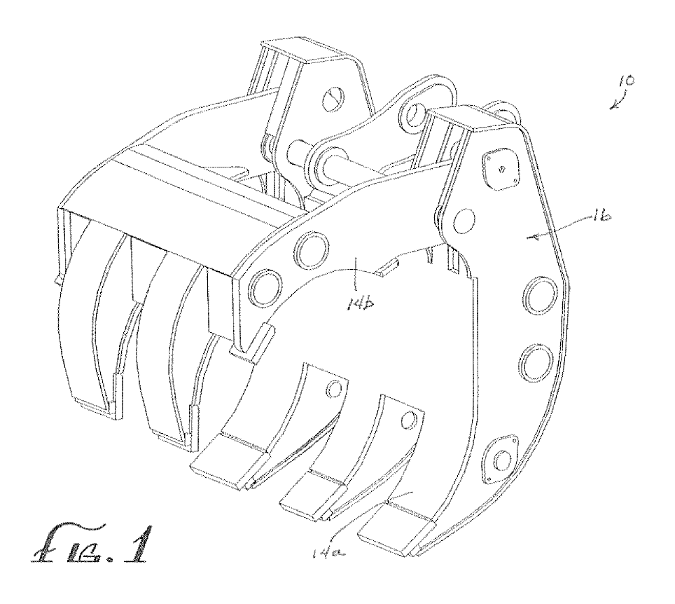

In the grapple of the invention 10, both hydraulic cylinders 12 may be completely enclosed within cover plates 16, as illustrated in FIG. 1. Each hydraulic cylinder 12 is wholly enclosed within a compartment within the first jaw 14a. This feature of the invention prevents damage to the hydraulic cylinders 12 from materials that the grapple 10 is picking up. The hydraulic cylinders 12 are, however, easily accessible for adjustment and/or maintenance by the removal of the cover plates 16.

A distinct difference between the grapple of the invention 10 and prior art grapples is that both hydraulic cylinders 12 are configured so as to be capable of opening and closing the hinged jaws 14 without the use of a stiff arm. Thus, the grapple of the invention 10 can be easily attached to a quick coupler and to hydraulic supply hoses, allowing the hydraulic functions of the grapple of the invention 10 to be controlled by the operator inside the cab of the grapple 10.

The grapple of the invention 10 can be used for all types of material handling and earth-moving equipment. The grapple of the invention 10 is designed to unload and load trucks as well as various types of equipment. The grapple of the invention 10 can fit machines from 2000 pounds to 300,000 pounds. Such machines are typically back hoes, excavators, graders and telescoping types of excavation and grading machines.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A grapple comprising:
(a) a first jaw hinged together with a second jaw; and
(b) a pair of hydraulic cylinders disposed on opposite sides of the jaw, both cylinders capable of opening and closing the hinged jaws without the use of a stiff arm.

2. A grapple comprising:
(a) a first jaw hinged together with a second jaw; and
(b) a pair of hydraulic cylinders disposed on opposite sides of the first jaw, both cylinders being fully enclosed within a compartment within the first jaw.
